(19) United States
(12) Patent Application Publication
(10) Pub. No.: US 2023/0290079 A1
(43) Pub. Date: Sep. 14, 2023

(54) SYSTEM FOR AUGMENTED REALITY

(71) Applicant: POLITECNICO DI MILANO, Milano (IT)

(72) Inventors: Gaetano CASCINI, Milano (IT); Giandomenico CARUSO, Milano (IT); Niccolò BECATTINI, Milano (IT); Federico MOROSI, Milano (IT)

(21) Appl. No.: 18/006,245

(22) PCT Filed: Jul. 20, 2021
(86) PCT No.: PCT/IB2021/056551

§ 371 Date: Jan. 20, 2023

(30) Foreign Application Priority Data
Jul. 21, 2020 (IT) 102020000017653

(51) Int. Cl. G06T 19/00; H04N 9/31; G06T 7/70; G06F 3/041

(52) U.S. Cl. CPC G06T 19/006; G06F 3/041; G06T 7/70; H04N 9/31; G06T 2207/30204

(57) ABSTRACT

It is disclosed an augmented reality system comprising at least one projector, a detection surface and at least one marker. The projector is configured to project a digital image onto a physical object inside a projection volume. The at least one marker is couplable to the physical object and it is adapted to engage the detection surface in at least one point of contact, thus generating a detection signal representative of one or more properties of the point of contact. The detection surface is configured to identify in use an absolute position and an orientation of the physical object coupled to the marker inside the projection volume as a function of the detection signal.

### BACKGROUND

### Technical Field

The present disclosure relates to a system for augmented reality and the method thereof for generating augmented reality images.

### Description of the Related Art

Augmented reality technology allows to present digital contents by overlapping them at least partially with a real environment.

In this context the Spatial Augmented Reality (SAR) is of particular interest with which it is possible to project the digital content directly on one or more surfaces of a physical object, without requiring the use of individual devices such as special viewers for augmented reality.

The use of suitable tracking devices allows to update the projection to adapt it to the position and orientation of the physical object on which the projection is to be carried out when it is moved within the working area wherein the projection is being carried out.

The overlap of physical and virtual contents in the same environment improves the understanding of complex digital information thanks to a more effective representation of digital data, in terms of space and tangible properties, making a faster prototyping technique of real models available.

In fact, through the SAR technology it is possible to prepare a single physical object presenting the structural conformation of the product to be made and on which a digital content is simply projected, which can be easily updated, modified and applied in real time on the physical object. without the need to create a succession of physical models for each prototype to be created.

Another advantage of the SAR technology is that of allowing high flexibility of use due to the possibility of hands-free interactions with physical objects and without the use of viewers for viewing digital contents.

In general, a SAR system is thus composed of the physical objects on which the projection of digital contents is to be carried out, the projectors themselves and the tracking devices that are used to detect the three-dimensional position and the orientation of the physical object.

The known tracking devices are based on the use of optical, inertial, acoustic, mechanical, electromagnetic and radio sensors whose advantages and disadvantages are widely discussed in the literature.

Among the possible alternatives made available by the prior art, infrared (IR) optical tracking devices are the most common in the field of SAR applications thanks to the tracking accuracy, the limited sensitivity to partial occlusions of the visual field and the use of limited invasive markers for the recognition of the physical object to be augmented, or on which the projection of the digital content must be carried out.

However, all known tracking devices, even those of the infrared type, are affected by drawbacks and limitations which make the spread and use of the SAR technology difficult, especially in the industrial field.

In fact, in order to operate, the known systems require expensive and complex configuration procedures to be executed in which a plurality of operating parameters of the projectors and of the tracking system itself are initialized to allow the coupling between the two and the subsequent alignment between the physical object and the virtual representation thereof.

This configuration procedure is not very flexible and unable to adapt to possible structural changes in the system or even just some of the parts thereof or to changes in the environmental conditions in which the system operates.

Furthermore, both the structural complexity and the operational level of known tracking systems require the intervention of highly qualified personnel in order to guarantee the correct use thereof.

### BRIEF SUMMARY

In this context, the technical task underlying the present disclosure is to propose a system for augmented reality which overcomes at least some of the drawbacks of the prior art cited above.

In particular, one embodiment of the present disclosure is a system for augmented reality capable of identifying in a simple and efficient manner the relative position between the projector and the physical object on which the digital content is to be projected.

The technical task set and the objects specified are substantially attained by a system for augmented reality, comprising the technical features set forth in one or more of the appended claims.

According to the present disclosure, a system for augmented reality is shown which comprises at least one projector, a detection surface and at least one marker.

The projector is configured to project a digital image onto a physical object inside a projection volume.

The at least one marker is couplable to the physical object and it is adapted to engage the detection surface in at least one point of contact, thereby generating a detection signal representative of one or more properties of the point of contact.

In particular, the detection surface is configured to identify in use an absolute position and an orientation of the physical object coupled to the marker inside the projection volume as a function of the information content of the detection signal.

Therefore the detection of the arrangement of the physical object inside the projection volume (and thus with respect to the projector) takes place through the physical contact between the object itself and the detection surface created by means of the marker, thus obtaining a mechanism of particularly reliable and precise detection.

One embodiment of the present disclosure is a method for displaying in augmented reality a digital content which is performed by engaging in at least one point of contact a physical object with a detection surface.

In one embodiment, the contact between the physical object and the detection surface is mediated by a marker interposed between the two which defines one or more properties of the point of contact, in particular a conformation (i.e. the shape), the dimensions and a positioning of the point of contact inside the detection surface.

Therefore it is generated a detection signal representative of one or more properties of the at least one point of contact according to which an absolute position and an orientation of the physical object inside the projection volume are identified.

Finally, once the position of the physical object is known, the digital content can be projected onto it.

The dependent claims, incorporated herein by reference, correspond to different embodiments of the disclosure.

### BRIEF DESCRIPTION OF THE SEVERAL VIEW OF THE DRAWINGS

Further characteristics and advantages of the present disclosure will become more apparent from the indicative and thus non-limiting description of a preferred, but not exclusive, embodiment of a system for augmented reality, as illustrated in the accompanying drawings, wherein:

FIG. 1A schematically shows a possible embodiment of some components of a system for augmented reality;

FIG. 1B schematically indicates some components of the system highlighting the signals used for the operation thereof;

FIGS. 2A-2C show possible embodiments of respective configurations of use in which a marker is applied to a physical object.

### DETAILED DESCRIPTION

In the appended figures, the numerical reference 1 indicates in general a system for augmented reality, to which reference is made in the following of the present description simply as system 1.

Structurally, the system 1 comprises at least one projector 2, a detection surface 3, at least one marker 4 and a processing unit 5 (for example, a microprocessor).

The projector 2 is configured to project a digital content onto a physical object “O” inside a projection volume “P” which is within the visual field of the projector 3.

The digital content encloses, for example, graphic information projected directly on the external surface of the physical object “O”.

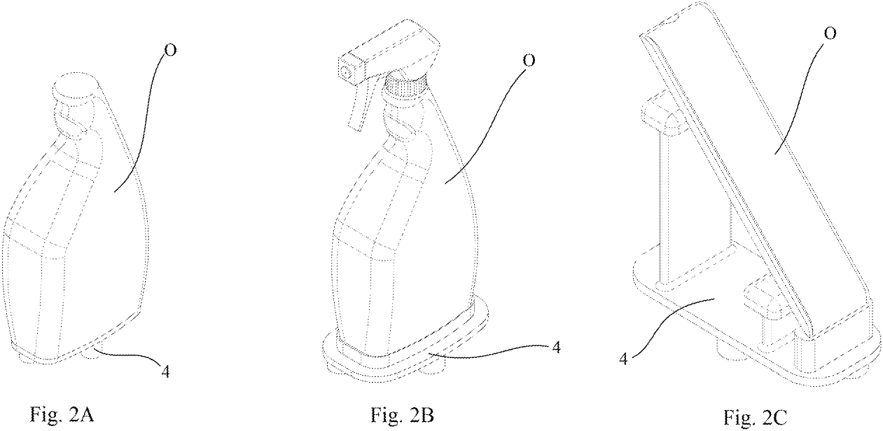

In accordance with a preferred embodiment, illustrated in FIG. 2B, the detection surface 3 helps to define the projection volume “P”, that is to say that the projector 2 is arranged in such a way as to enclose the detection surface 3 inside one’s visual field.

Alternatively, the projection volume “P” could be at least partially or completely disjoint with respect to the detection surface 3, that is to say that the latter is placed at least partially or completely outside the visual field of the projector 2.

In this way it is possible to project digital contents even onto physical objects “O” which have shapes and/or dimensions such that they extend even outside the edges of the detection surface 3.

The detection surface 3 is in particular flat and cooperates with the at least one marker 4 to determine the position and orientation of the physical object “O” with respect to the at least one projector 2 inside this projection volume “P”.

The projector 2 has a relative position and orientation in space with respect to the detection surface 3 which are known; for example, as it will be explained in greater detail below, the projector 3 can be mechanically connected integrally to the detection surface 3.

More in detail, as it will be further explained below, the at least one marker 4 is a support which is couplable, in particular in a reversible manner, or which is integrable into the physical object “O”.

The at least one marker 4 is further adapted to engage the detection surface 3 in at least one point of contact.

Operationally, the relative position and orientation between the projector 2 and the physical object “O” is determined by combining the following information:
relative position and orientation of the projector 2 with respect to the detection surface 3 (known by construction or calculated during the operation of the system 1);
relative position and orientation of the physical object “O” with respect to the detection surface 3, obtained by means of:
   mechanical coupling of the physical object “O” with the marker 4;
   contact between the marker 4 and the detection surface 3, in one or more points of contact.

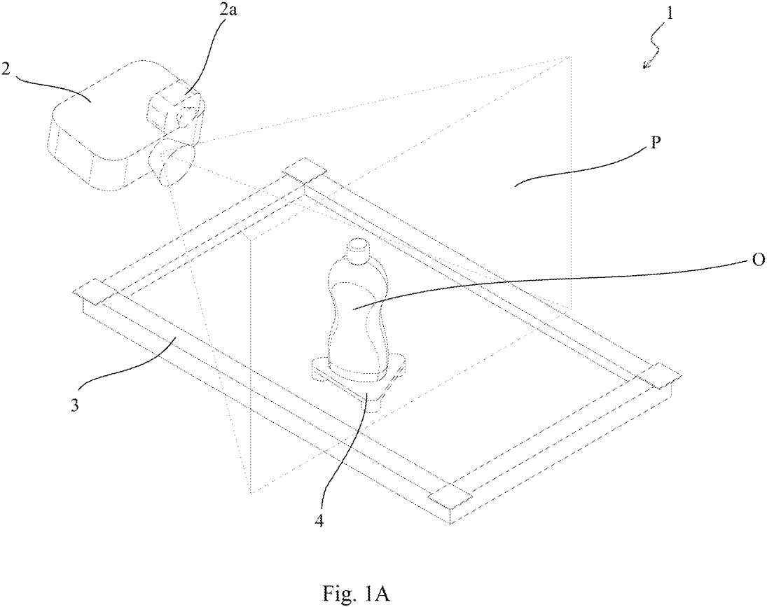

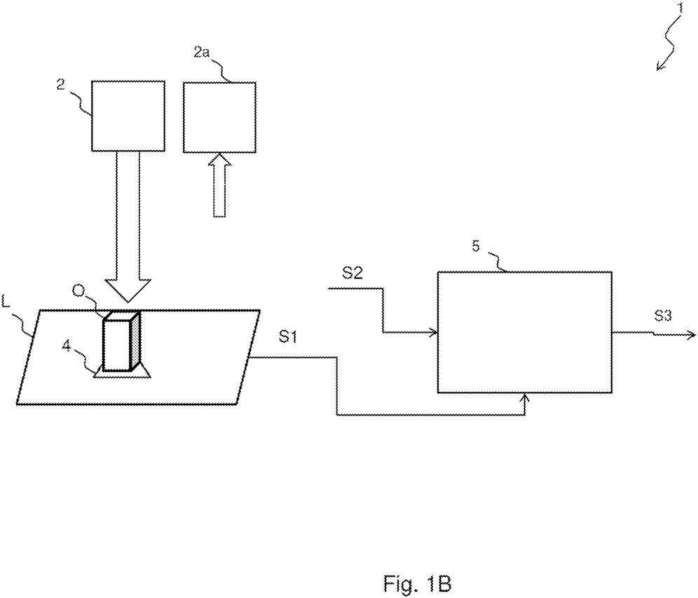

In detail, as represented in FIG. 1B, the processing unit 5 receives at the input a detection signal “S1” representative of one or more properties of the at least one point of contact and receives a reference signal “S2” representative of the relative position and orientation between the projector 2 and the detection surface 3.

As a function of these two pieces of information, the processing unit 5 generates the operating signal “S3” by which the position and orientation of the object “O” inside the projection volume “P” is indicated to the projector 2.

In this way, the projection of the digital content onto the surface of the physical object “O” is kept updated based on the position and orientation of the object “O” itself.

The interaction between the detection surface 3 and the marker 4 when the latter is leaning thereon, leads to the generation of said detection signal “S1”, which is representative of one or more properties of the point of contact.

In other words, the detection signal “S1” is a signal representative of at least one property of the point of contact which is defined when the marker 4 is placed in contact with the detection surface 3.

The term “properties of the point of contact” means for example the geometry of the point of contact, such as in detail the shape of the area defined by the point of contact, the dimension of the area defined by the point of contact and the distance of the point contact on the detection surface 3.

Consequently, the term “point of contact” does not only mean the point as an entity of Euclidean geometry that has no dimensions, but more generally with “point of contact” it is intended the physical portion of the marker 4 which is arranged to engage the detection surface 3, wherein said physical portion of the marker 4 defines a contact area having a specific predefined shape and dimension.

In general, the specific characteristics that can be monitored by the detection surface 3 (and thus integrated into the information content of the detection signal “S1”) depend on the specific structure and interaction existing between the detection surface 3 and the at least one marker 4.

For example, the detection surface 3 has a flat rectangular shape: in this case a Cartesian plane is defined on the flat detection surface 3 and the properties of the points of contact are the Cartesian coordinates of the points of contact between the detection surface 3 and the marker 4.

In general, the marker 4 is configured to interact with the detection surface 3 in such a way as to generate the detection signal “S1” when these two components are in mutual contact.

This detection signal “S1” is representative of the specific interaction established between the detection surface 3 and the marker 4 and it is used by the detection surface 3 itself to determine the positioning of the marker 4 (thus of the physical object “O” to which the latter is coupled) inside the detection surface 3.

In use, the detection surface 3 is thus configured to identify an absolute position and an orientation of the marker 4 inside it, allowing the processing unit to calculate the position in the three-dimensional space defined by the projection volume “P” of the physical object “O” coupled to marker 4 as a function of the detection signal “S1”, i.e. of the characteristics of the point of contact as they are detected by the detection surface 3.

In other words, the detection of the positioning and of the orientation of the physical object “O” inside the projection volume “P” is subject to the establishment of an interaction between the marker 4 associated with this physical object “O” and the detection surface 3.

Therefore, the detection surface 3 interacts with the marker 4 obtaining from this interaction the information of interest which allows the projector 2 to correctly apply the digital content onto the physical object “O”.

The processing unit 5 has the function of calculating the relative position and orientation between the projector 2 and the physical object “O”.

In particular, the processing unit 5 is configured to receive the detection signal “S1” and calculate therefrom a relative position and orientation between the detection surface 3 and the physical object “O”

Furthermore, the processing unit 5 is configured to calculate a relative position and an orientation between the at least one projector 2 and the physical object “O”, as a function of a relative position and orientation between the at least one projector 2 and the detection surface 3 (reference signal S2) and as a function of said relative position and orientation between the detection surface and the physical object.

The relative position and orientation between the at least one projector 2 and the detection surface 3 can be known in advance by means of the reference signal S2 (and thus it is a system configuration value), or it can be calculated by using an optical sensor 2a integrally connected to the at least one projector 2 and oriented towards the detection surface 3.

In detail, the processing unit 5 is integrable into the detection surface 3 or it can be made by means of a further external component connected or connectable with the other components of the system 1.

Furthermore, the processing unit 5 can comprise a memory for storing the unique coupling between a given marker 4 and the physical object “O” associated therewith.

In other words, the processing unit 5 contains a piece of information that allows the system to uniquely identify the shape, the dimension and the orientation of the physical object once the specific marker 4 which is interacting with the detection surface 3 has been recognized.

This information can be contained in a preset memory in which each marker 4 is coupled to a specific physical object “O”, indicating in particular in which point of the physical object “O” the marker 4 is applied.

The memory is also configurable by a user in order to modify the information contained therein, so as to allow system 1 to take into account any structural changes that are made to the physical object “O” or to allow the user to couple a certain marker 4 to a new physical object “O”.

In one embodiment, the detection surface 3 comprises a first portion configured to be engaged by the at least one marker 4 and a second portion in which for example a user interface can be displayed.

In accordance with a possible embodiment, the first and second portion are distinct and separate from each other, so as to define a zone aimed solely at supporting the physical object “O” coupled to the marker 4 and a zone used for example for presenting information and/or receiving inputs from a user.

In this context, the visual field of the projector 2 can also coincide only with the first portion since it may not be necessary to project digital contents inside the second portion.

In accordance with a further possible embodiment, the first and second portion are at least partially overlapped, in particular the first and second portion are completely overlapped.

In other words, the first and second portion can coincide, so that the entire detection surface 3 can be used to define both a leaning zone for the detection of the physical object “O” and a user interface at the same time.

In both contexts outlined above, the second portion can present a user interface made by means of an output video peripheral with which the user is provided with information on the operating conditions of the system 1 or data and information related to the digital content being projected or even related to the physical object “O” on which the projection is being carried out.

Alternatively, the second portion can present a user interface made by means of both an output and input peripheral, for example a touchscreen, in such a way as to allow configuring this second portion not only for the presentation of information to a user, but also as a control interface through which the user can modify the operating conditions of the system 1.

By way of example, through this user interface, the user can modify the digital content that is projected onto the physical object “O” and/or one or more operating parameters of the projector 2 (brightness, colour tone, focus ...), of the detection surface 3 or of the marker 4.

In particular, the detection surface 3 can comprise a multi-touch screen of the capacitive type which extends over at least part of the first portion and/or of the second portion.

In one embodiment, the touchscreen extends over the entire detection surface. In accordance with these aspects, the detection surface 3 is thus defined by a touchscreen and the detection signal “S1” is in particular a signal of the capacitive type generated by the contact of the marker 4 with the detection surface 3.

More in detail, the marker 4 is configured to engage the detection surface in a single point of contact which has a rotationally asymmetrical conformation (i.e. a shape) and the detection signal “S1” has an information content that uniquely identifies the conformation (i.e. shape) of this point of contact.

The term rotationally asymmetrical means that it is possible to determine at any time in a precise and unique way how the point of contact (and thus the marker 4 in general) is oriented (i.e. the direction) with respect to a reference point that can be defined by an absolute reference (a specific spatial coordinate such as a cardinal point) or a relative reference (a preset point of the detection surface 3 or the position of the projector 2).

In other words, the marker 4 has a conformation (i.e. a structure) such that when it interacts with the detection surface 3, it engages it in a point of contact which has a conformation (i.e. the shape) whereby the determination of the orientation of the marker 4 inside the detection surface 3 in a unique manner and thus the calculation of the position/orientation in the projection volume “P” of the physical object “O” coupled thereto are immediate.

Alternatively, the marker 4 is configured to engage the detection surface in a plurality of points of contact that define and delimit as a whole a rotationally asymmetrical shape (i.e. a contour) and the detection signal “S1” has an information content that identifies in a unique manner the conformation (i.e. the shape) of this shape (contour).

In accordance with a preferred embodiment, the marker 4 comprises a pedestal which is couplable to a face of the physical object in which the points of contact with the detection surface are defined by the leaning point(s) for this pedestal.

In detail, the marker 4 can be made as one piece or integrated with the physical object “O”, for example the marker 4 can be co-moulded or coextruded during the realisation of the physical object “O”.

In this context, the marker thus defines a portion, for example, of a face of the physical object “O” and it is bound thereto in an irreversible manner.

Alternatively, the marker 4 can be made by means of a distinct element that is reversibly or irreversibly applicable to the physical object “O”.

In this context, the marker 4 can be made for example by means of a pedestal having a coupling means, in particular a coupling means of a mechanical type such as clamps or a snap coupling device.

In accordance with an aspect of the present disclosure, the system 1 comprises a plurality of markers which are couplable to respective distinct faces of the physical object “O”, each of which is configured to generate a respective unique detection signal “S1”.

It is also possible to provide one or more markers 4 integrated into the physical object “O” used in combination with one or more markers 4 which are couplable thereto.

In this way it is possible to rotate the physical object “O” around each of its axes while always keeping one of the faces thereof in contact with the detection surface 3 by means of the respective marker thereof 4.

In fact, in each face there is a different marker 4 which, by means of the information content enclosed in the detection signal “S1” (generated by the interaction of that specific marker 4 with the detection surface 3), allows to easily and uniquely determine the orientation and the position in space of the physical object “O”.

The system 1 can further comprise a support frame coupled with the detection surface 3 and with the at least one projector 2 so as to support the at least one projector 2 in a position that is fixed and predetermined with respect to the detection surface 3.

In this way, during the use of the system 1, the relative position between the projector 2 and the detection surface 3 is always kept fixed, making the system more stable and avoiding the risk of accidental movements of the projector 2 which could accidentally misalign the projection of the digital content with respect to the physical object “O”.

Alternatively, in accordance with a further aspect of the present disclosure, the system 1 comprises a three-dimensional movement member coupled with the at least one projector 2 and configured to move it with respect to the detection surface 2.

In this way the system 1 is more elastic allowing the position of the projector 2 to be modified according to the operational needs of use, for example according to the dimensions or shape of the physical object “O” onto which the content is to be projected digital.

In order to guarantee also in this context at all times the positioning of the projector with respect to the detection surface 3, thus with respect to the physical object “O”, the system further comprises an optical sensor 2a configured to determine a relative position between the projector 2 and the detection surface 3.

Said optical sensor 2a may comprise for example a video camera or a camera or any sensor capable of detecting the presence of the detection surface 3 so as to be able to determine the relative position thereof with respect to the projector 2.

For this purpose, the detection surface 3 can in turn comprise an indicator couplable to the optical sensor 2a or in any case configured to be uniquely detected by the optical sensor 2a in order to determine the position thereof.

More in detail, the optical sensor 2a is configured to determine the relative position between the projector 2 and the detection surface 3 by means of at least one of the following algorithms: triangulation, contour recognition or pattern matching.

Advantageously, the detection surface 3 (for example of the multi-tactile type) comprises one or more visual indicators positioned along at least part of the edge of the same detection surface 3: this allows to facilitate the identification of the position and orientation of the detection surface 3 with respect to the projector 2.

For example, the detection surface has a rectangular shape: in this case there is a visual indicator (for example, a notch) positioned in a vertex of the rectangle.

According to a possible embodiment, the system 1 comprises a plurality of projectors 2 which are arranged around the detection surface 3 so as to define in use a visual field of 360° around the physical object “O”.

In other words, the projectors 2 are positioned so as to allow the application of a digital content on all the faces of the physical object “O” at the same time, regardless of the shape of this physical object “O”.

In this way it is possible to simultaneously use the entire available surface of the physical object “O” as a support for the projection of digital contents, thus allowing more complete information to be available.

In general, each projector 3 is couplable to a fixed frame or to a three-dimensional movement member.

The system 1 can further comprise at least one output peripheral configured to generate a sensor signal which can be used to provide the user with further information regarding the operating conditions of the system 1 or the physical object “O”.

In detail, the at least one output peripheral is configured to generate a sensor signal comprising at least one of: an optical signal, an acoustic signal, a tactile signal, an olfactory signal, a vibrational signal.

In one embodiment, the at least one output peripheral is integrated with the detection surface or with any other structural component of the system 1 (such as for example the projector 2).

Alternatively, the at least one output peripheral can be made by means of a distinct and separate component in particular placed in correspondence of or adjacent to the detection surface 3 and connected thereto or to another component of the system 1 to be activated by the latter, for example as a function of the characteristics of the digital content being projected.

Alternatively, the system 1 can comprise a plurality of output peripherals of which at least one is integrated with the detection surface (or with a further component of the system 1) and at least one made by means of a distinct and separate component.

Advantageously, the present disclosure achieves the proposed objects, overcoming the drawbacks complained of in the prior art by providing the user with a system for augmented reality which allows to identify precisely and efficiently in a continuous manner the positioning and the orientation of the physical object onto which it is wished to project the digital content.

In this way, during the use of the system 1, a high quality level of the projection process is guaranteed as the projector 2 will always apply the digital content onto the physical object “O” in a precise and correct manner.

The present disclosure also relates to a method for displaying in augmented reality a digital content.

In particular, the method described herein is in particular executable using a system for augmented reality having one or more of the characteristics discussed above. Operationally, the method is executed by engaging in at least one point of contact a physical object “O” with a detection surface 3.

In other words, the physical object “O” is leaning on the detection surface 3.

As indicated above in the discussion related to system 1, the physical object “O” is associated with a marker 4 (integrated or not into the physical object “O” itself) specially designed to interact with the detection surface 3.

As a function of the interaction that is established between the detection surface 3 and the physical object “O”, a detection signal “S1” is generated which is representative of one or more properties of the at least one point of contact, in particular of a conformation (i.e. a rotationally asymmetric shape) and a position of the point of contact within the detection surface 3.

The information contained in the detection signal “S1” thus allows identifying an absolute position and an orientation of the physical object “O” inside a projection volume “P”.

Once the position and orientation of the physical object “O” has been established, the desired digital content is projected onto it.

Subsequently, the property of the point of contact of interest is continuously monitored and whenever a variation thereof is identified, a new detection signal “S1” is generated which identifies the new absolute position and the orientation of the physical object “OR”.

Furthermore, a possible variation of at least one property of the point of contact could also be determined from a change of the marker 4 present on the detection surface 3 (for example because the physical object “O” onto which a projection is to be made has been replaced), thus the method also provides for identifying the specific marker 4 which engages the detection surface 3 whenever the properties of the point of contact change.

In particular, this identification can be performed by inspecting certain properties of the point of contact, i.e. each marker 4 could be uniquely associated with a particular conformation (shape) and/or dimension of the point of contact (intended as an area) that it defines when it engages the surface detection 3.

In this context, the new detection signal “S1” will be uniquely recognised as generated by a specific marker 4 and thus by a specific physical object “O” associated with this marker 4, thus allowing the digital content to be projected correctly taking into account the absolute position of the orientation and also of the conformation (structure) of the physical object “O” inside the projection volume “P”.

Advantageously, the present disclosure achieves the proposed objects, overcoming the drawbacks complained of in the prior art by providing the user with a method for displaying in augmented reality an easy-to-execute digital content which reduces the burden and the complexity in particular of the operations of preparation and installation of the system 1 in charge of augmenting a physical object “O”.

1. A system for augmented reality comprising:
at least one projector configured to project a digital content onto a physical object inside a projection volume;
a detection surface;
at least one marker couplable with or integrable into the physical object and adapted to engage the detection surface in at least one point of contact, generating a detection signal representative of one or more properties of the at least one point of contact, including of a conformation and of a position of the point of contact inside the detection surface;
a processing unit configured to:
• receive the detection signal and calculate therefrom a relative position and orientation between the detection surface and the physical object;
• calculate a relative position and orientation between the at least one projector and the physical object, as a function of a relative position and orientation between the at least one projector and the detection surface and as a function of said relative position and orientation between the detection surface and the physical object.

2. The system according to claim 1, wherein the detection surface comprises a touchscreen and the detection signal is an electric signal generated as a function of the contact between the marker and the detection surface in the at least one point of contact.

3. The system according to claim 1, wherein the detection surface comprises a first portion that is engageable by the marker and a second portion configured to display a user interface.

4. The system according to claim 3, wherein the first and the second portion are at least partially overlapped, in particular the first and the second portion are completely overlapped.

5. The system according claim 1, wherein the marker is configured to engage the detection surface in a single point of contact having a rotationally asymmetric conformation, said detection signal being representative of the conformation of said point of contact.

6. The system according to claims 1, wherein the marker is configured to engage the detection surface in a plurality of points of contact defining a rotationally asymmetric shape, said detection signal being representative of the conformation of said shape.

7. The system according to claim 1, wherein the at least one marker comprises a pedestal couplable with a face of the physical object.

8. The system according to claim 1, comprising a plurality of markers couplable with or integrable into respective distinct faces of the physical object, each marker being configured to generate a respective unique detection signal.

9. The system according to claim 1, comprising at least one physical object, said at least one marker being coupled with or integrated into a face of said physical object.

10. The system according to claim 1, comprising a support frame coupled with the detection surface and with the at least one projector so as to support the at least one projector in a position that is fixed and predetermined with respect to the detection surface.

11. The system according to claim 1, comprising a three-dimensional movement member coupled with the at least one projector to move said projector with respect to the detection surface.

12. The system according to claim 11, comprising an optical sensor, in particular integrally connected to the at least one projector and oriented towards the detection surface, wherein the processing unit is further configured to determine the relative position between the projector and the detection surface by means of at least one of a triangulation algorithm, a recognition of the contours algorithm or a pattern matching algorithm.

13. The system according to claim 1, comprising a plurality of projectors arranged around the detection surface so as to define in use a visual field of 360° around the physical object.

14. The system according to claim 1, comprising at least one output peripheral configured to generate a respective sensor signal, said sensor signal comprising at least one of: an optical signal, an acoustic signal, a tactile signal, an olfactory signal, a vibrational signal, in particular said output peripheral being integrated with the detection surface.

15. A method for displaying in augmented reality a digital content, the method comprising:
engaging in at least one point of contact a physical object with a detection surface;
generating a detection signal representative of one or more properties of the at least one point of contact, including of a conformation and of a position of the point of contact inside the detection surface;
identifying an absolute position and an orientation of the physical object inside a detection area as a function of the detection signal;
projecting a digital content on the physical object inside a projection volume.

16. The system according to claim 2, wherein the detection surface comprises a first portion that is engageable by the marker and a second portion configured to display a user interface.

17. The system according to claim 16, wherein the first and the second portion are at least partially overlapped, in particular the first and the second portion are completely overlapped.

18. The system according claim 2, wherein the marker is configured to engage the detection surface in a single point of contact having a rotationally asymmetric conformation, said detection signal being representative of the conformation of said point of contact.
